(19) United States
(12) Patent Application Publication
(10) Pub. No.: US 2003/0115107 A1
(43) Pub. Date: Jun. 19, 2003

(54) Method and system for cart transfer in electronic commerce

(76) Inventors: Robert N. Amensen, Newton, IA (US); Mark S. Monroe, Newton, IA (US); Colin C. Bain, Longmont, CO (US)

Correspondence Address: MCKEE, VOORHEES & SEASE, P.L.C., ATTN: MAYTAG, 801 GRAND AVENUE, SUITE 3200, DES MOINES, IA, 50309-2721, US

(21) Appl. No.: 10/022,639

(22) Filed: Dec. 17, 2001

(51) Int. Cl. G06F 17/60

(52) U.S. Cl. 705/26

(57) ABSTRACT

The present invention includes an electronic commerce system for transfer of product purchase selection having a first website adapted to communicate product information to consumers and adapted to receive at least one product purchase selection from a consumer, a shopping cart associated with the consumer and adapted to maintain the product purchase selection, and a cart transfer for transferring the product purchase selection from the shopping cart to a second shopping cart associated with the second website.

### BACKGROUND OF THE INVENTION

The present invention is a method and system for product purchases using electronic commerce. More particularly, the invention relates to transferring product selections, such as those contained in a shopping cart of a first website to a shopping cart of a second website.

### PROBLEMS IN THE ART

Electronic commerce, including Internet commerce has grown rapidly in recent years. Electronic commerce can provide a number of advantages, not just to consumers, but to manufacturers as well. For example, the Internet provides manufacturers with a direct communication channel to consumers. Therefore, the advent and popularity of the Internet and electronic commerce allows manufacturers to sell directly to consumers.

Despite the advantages of using the Internet for electronic commerce, problems remain. The advantage that manufacturers have in that the Internet facilitates direct contact with consumers can tend to alienate relationships involving others. For example, a manufacturer may sell appliances such as refrigerators, ovens, electric ranges, dishwashers, clothes washers and dryers. In addition, the manufacturer may have developed a high level of name brand recognition and goodwill associated with its products over the years. The same manufacturer may have also developed a number of distribution channels for its products and a number of associations with various retailers, stores and others who may sell or service the products.

The direct connection between consumers and the manufacturer, made possible by the Internet, can strain the relationship between the manufacturer and others. Some have looked to the Internet and electronic commerce to eliminate all so called “middle men” and encourage direct sales from manufacturers to consumers. Therefore, there is a problem with how these business dynamics should change in light of electronic commerce. Electronic commerce creates a channel conflict between retailers and manufacturers. Electronic commerce can place the manufacturer in direct competition with its retailer for the same consumer. Thus a manufacturer can potentially steal a sale from the retailer, creating a channel conflict and straining the relationship between retailers and manufacturers.

Instead of direct sales from a manufacturer to a consumer, other approaches have also been used. One such approach is for a manufacturer website to merely contain links to various retailers. Then, consumers drawn to the website of the manufacturer who seek to order online, must follow a link to one of the distributors, stores, or other retailers linked to the manufacturer. There are a number of problems with using simple link-outs. One problem with merely providing links from manufacturer's website to distributor or store websites is that it limits the manufacturer's ability to record consumer information. This information may include the name, address, Email address, product selected, channel or customer used, and other information associated with the consumer that can be valuable to future marketing efforts. Typically, consumers who use the Internet are unwilling to be inconvenienced with providing this type of personal information unless necessary for an order. Therefore, when links to resellers or stores are used, it is difficult for a manufacturer to collect this information in a manner that is non-intrusive to consumers. A consumer may be amenable to providing this information as a part of the online ordering process, but may not want to provide this information merely to provide marketing information. Therefore, a problem remains in how a manufacturer can receive this consumer information.

A further problem with simple link-outs is that consumers starting on a manufacturer's web site must go through an entire navigation process to find the product they want. This process must then be duplicated on the retailer's site. This redundancy is not well received by consumers. The mere inclusion of links from a manufacturer's web site to retailer web sites adds very little value to a manufacturer's web site.

A further problem is that if a consumer desires to check price and availability with more than one retailer, they must repeat the entire navigation process in each of the retailer's web sites. This process is likely to be considered overly burdensome to many consumers.

A further problem with simple link-outs to other sites is that it reduces or eliminates a manufacturer's ability to channel the consumer through the buying process. This includes information provided to the consumer prior to product selection and other aspects of a guided selling process.

Other problems occur if a manufacturer relies on its retailers to provide online selling. One problem is that retailers may not have the product expertise of the manufacturer and may not provide a system that allows a consumer to select the proper products.

A further problem is that the retailer may not provide as much product information as would be accessible on a manufacturer's web site. Further, the retailer's information may not be as current as the information available on a manufacturer's web site. Therefore, problems remain when the manufacturer relies on the web sites of retailers to promote and sell its products.

Another approach that a manufacturer may take is to maintain an online store and then have customer sites, or other affiliated websites such as may be associated with a distributor or store, direct consumers to the manufacturer's website. The term “customer” is used broadly to denote an entity that is a supplier, distributor, carries a manufacturer's products or services, retailer, or other. The manufacturer's website can then provide for selecting the product and ordering the product. The manufacturer's website then directs the customer to the order so the customer, can deliver or fulfill the order. This type of program is known as a Private Labeling Program. As can be appreciated, there are problems with this type of program. In particular, a customer or manufacturer may not be willing to agree to these terms. This can also provide inconveniences for a purchaser who goes first to a customer website but must then be directed through a manufacturer's website in order to conduct a purchase. This is particularly inconvenient if a purchaser wanted to purchase multiple items from an online store which requires that the purchaser navigate through multiple manufacturer websites even though the purchaser may have gone first to a particular online store. Therefore problems remain with this approach.

Another type of program is an associates program. In an associates program, a customer website can direct a purchaser to the manufacturer's online store. A purchaser can then choose a product and provide shipping information. The manufacturer's website can then solicit a fulfillment agent or can assign a fulfillment agent and then the manufacturer has the order fulfilled. The referral customer website then may receive a portion of the proceeds of the sale.

Problems remain with the associate's model. In particular, a customer may view it as a problem in that the customer loses control of the purchase. Further, the customer is no longer in charge of setting the price for would be purchasers as this duty is shifted to the manufacturer. The customer also loses the ability to provide fulfillment of the product purchase. This type of program diminishes the role of the customer in the sale. Therefore problems remain with the associates program approach.

A further problem with these various business models for conducting electronic commerce is that these business models are not necessarily consistent with the way a manufacturer historically conducts business, its strategy, and its approach to implementing its strategy. In other words, these methods and systems of electronic commerce are not necessarily consistent with the value chain of a manufacturer. The “value chain” being the way that the manufacturer performs individual activities that are consistent with its history, its strategy and its approach to implementing the strategy.

In particular, prior art electronic commerce methods are not conducive to a manufacturer being able to maintain its relationship with its customers. Thus, there are a number of needs not currently being addressed related to electronic commerce.

Therefore, it is a primary object of the present invention to provide a method and system that improves upon the state of the art.

It is a further object of the present invention to provide a method and system of electronic commerce that allows a manufacturer to facilitate a sales process from initial interest through purchase.

It is a further object of the present invention to provide a method and system for electronic commerce that allows a manufacturer to include its customers in its overall electronic commerce strategy.

It is a still further object of the present invention to provide a method and system of electronic commerce that allows a manufacturer to share a consumer relationship with a customer.

It is a further object of the present invention to provide a method and system for electronic commerce that is convenient for consumers to conduct electronic transactions.

It is a further object of the present invention to provide a method and system for electronic commerce that allows consumers to select a product from a manufacturer that is recognized and trusted while maintaining the benefits of local purchase and service.

It is a further object of the present invention to provide a method and system for electronic commerce that allows consumers to be assured that they are purchasing from someone who provides authorized delivery and installation.

It is a still further object of the present invention to provide a method and system for electronic commerce that allows a distributed selling network to be integrated into a manufacturer's web site.

Yet another object of the present invention is to provide a method and system that provides for guided selling.

A further object of the present invention is to promote a method and system that channels a consumer through the buying process.

A still further object of the present invention is to provide a method and system of electronic commerce that allows a consumer to receive current product data from a manufacturer while receiving personalized local service, delivery and installation.

Yet another object of the present invention is to provide a method and system that provides the advantage of increased web exposure for retailers.

A still further object of the present invention is to provide a means to remove sell-side costs for retailers.

Yet another object of the present invention is to provide the opportunity for retailers to cross-sell merchandise to consumers.

Yet another object of the present invention is to provide a method and system of electronic commerce that is adaptable to numerous products.

A still further object of the present invention is to use an existing customer's sites and systems without having to create a new site specific only to one manufacturer.

Additional objects of the present invention will become apparent from the specification and claims.

### BRIEF SUMMARY OF THE INVENTION

The present invention relates to a method and system for improved electronic commerce that facilitates the participation of both a manufacturer (or source) and at least one retailer in the process. More particularly, the present invention is an apparatus and method for electronic commerce that provides for product purchase selections. According to the invention, a first website is adapted to communicate product information to consumers and is also adapted to receive product purchase selections from consumers. A consumer can select a product to purchase. The product purchase selection is then transferred from a first website to a second website so that the same product purchase selection is present on the second website. In one embodiment, a consumer can select a product to purchase and then place that product selection in a shopping cart. The cart is then transferred from a first website to a second website so that a shopping cart appears at a second website with the same contents.

The first web site can be a manufacturer's web site and the second web site can be a retailer's web site. In this context, the present invention allows a dual-sharing of a consumer between the manufacturer and the retailer. This dual-sharing provides advantages to the manufacturer, retailer, and consumer.

The manufacturer can learn online buying behavior of consumers without actually transacting a sale. The manufacturer can also perform one-to-one marketing with the consumers and maintains a closer relationship with the consumer. Also, the manufacturer maintains the opportunity to provide guided selling.

The retailer receives increased web exposure, and the invention can serve as an extension of the retailer's pre-existing Internet selling channel. As the invention promotes online sales, it provides the advantage of the removal of sell-side costs. Further, as the sales leads are due to the manufacturer, there are not customer acquisition and marketing costs associated with the sale. These sales also can create an opportunity for more than a one-time sale, as they can lead to a long-term relationship with consumers. In addition, the retailer is provided the opportunity to cross-sell other merchandise to the consumer.

The consumer also realizes certain advantages from the present invention. Product information and expertise is received directly from the manufacturer. The present invention allows consumers to have the capability to shop multiple retailers from a single web site in order to find pricing and availability that best meet their needs.

In this manner the present invention provides the advantage of an electronic commerce system that allows a manufacturer to share a consumer with its customers. The present invention allows the manufacturer web site to be involved in the product selection process, while allowing one or more customers to be involved in the product purchase process.

### BRIEF DESCRIPTION OF THE DRAWINGS

The present invention is illustrated by way of example and not limitation in the figures of the accompanying drawings in which like references indicate similar elements.

FIG. 1 is a flow diagram of a method of the present invention.

FIG. 2 is a pictorial representation of a view cart web page of the present invention.

FIG. 3 is a graphical representation of a website page of the present invention providing a consumer's ability to select an online partner store.

FIG. 4 is a graphical representation of a web page of the present invention displaying pricing information concerning the product.

FIG. 5 is a graphical representation of a web page of the present invention located at a store website and not a manufacturer website.

FIG. 6 is a flow chart of one embodiment of the present invention that provides for the contents of one cart to be transferred to the contents of a second cart.

FIG. 7 is a flow chart of another embodiment of the present invention that provides for the transfer of a cart from a first web page to a second web page.

FIG. 8 is a flow chart of another embodiment of the present invention that provides for the transfer of a cart from a first website to a second website.

FIG. 9 is an XML embodiment of a cart transfer component of the present invention.

FIG. 10 is an XML embodiment of a check price and availability component of the present invention.

### DETAILED DESCRIPTION OF THE INVENTION

The present invention relates to a system and method for improved electronic commerce that allows a manufacturer and a customer to share a consumer relationship. The consumer can visit a manufacturer web site. At the manufacturer web site, the manufacturer can channel the consumer through the buying process. This includes receiving consumer preferences, providing information about products or otherwise assisting the consumer. Once a product purchase selection is made, according to the present invention the product purchase selections, such as those contained in a shopping cart, are transferred to a customer web site. Although the term “cart” or “shopping cart” is used throughout the disclosure, it is to be appreciated that other names are commonly given to a shopping cart. For example, a “shopping cart” or “cart” may also be called a “shopping basket,” “shopping bag,” or other container which a consumer may use to hold items to purchase prior to checking out or otherwise completing a transaction. The Applicants' use of the term “cart” encompasses these and other variations.

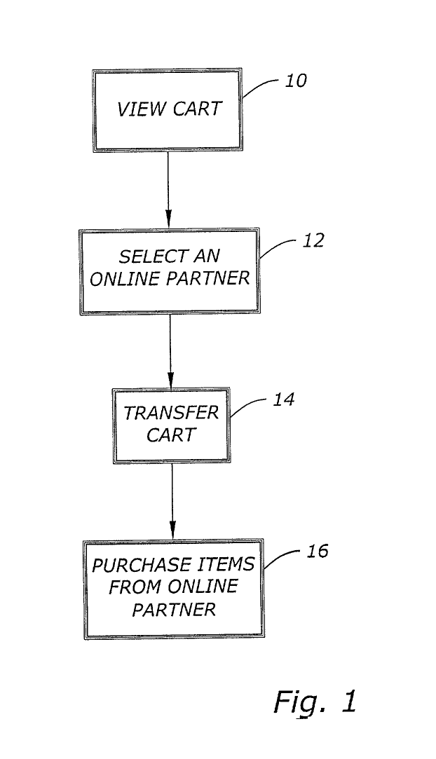

FIG. 1 provides an overview of one method of the present invention. In step 10 of FIG. 1, a consumer visiting the website can view a cart. The cart contains product purchase selections that the consumer has made and placed in the shopping cart. These product purchase selections are items the consumer is considering for purchase. The consumer visiting a website can enter a zip code, then select an online partner store in step 12. The online partner store in their area is a customer of the manufacturer, or otherwise has a relationship with the manufacturer. Once an online partner store is selected in step 12, the cart is transferred from a first website to a second website in a transfer cart step 14. Then the purchase of the items is completed in step 16. The purchase of items is from the selected online partner store, and not directly from the manufacturer.

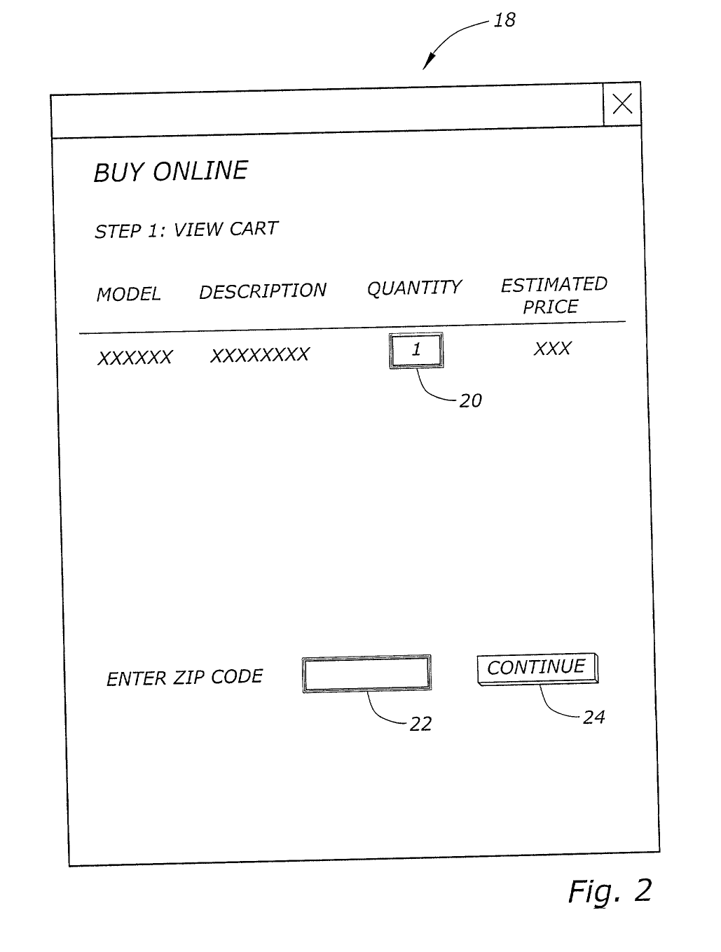

In FIG. 2, web page 18 is shown such as would be shown in the “view cart” step. On web page 18, information such as model number, description, a user editable quantity 20 and estimated price are shown. A consumer or other purchaser visiting a manufacturing website can view the items added to the cart on web page 18. The consumer can adjust the quantity of items by adjusting the number within input box 20. The consumer can also enter a zip code in the input box 22 to which the product should be shipped or delivered. Then the consumer can select a “continue” button 24 to get a listing of dealers in their area or to otherwise indicate that the consumer has entered the appropriate information and proceed to the next step in the ordering process.

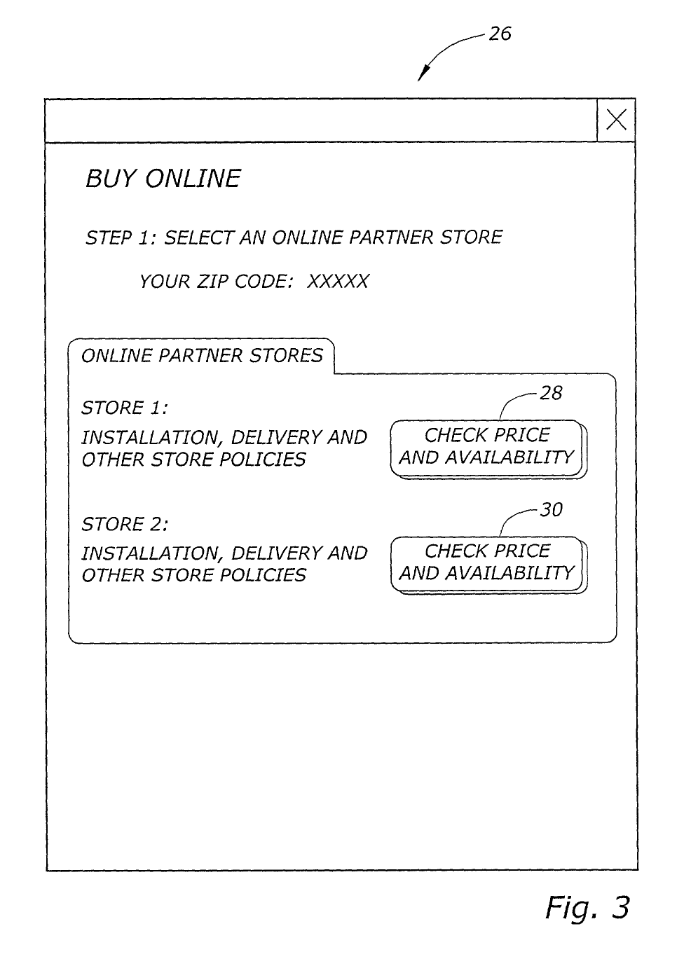

In FIG. 3, a web page 26 is shown. The web page 26 lists those partner stores or distributors for the specified zip code. For example, two stores may be listed. The consumer may then check out price and availability at either store by selecting the “check price and availability” button 28 to specify store 1 or the “check price and availability” button 30 to specify store 2. In addition, the consumer can follow the links to review installation, delivery, and other store policies associated with any of the stores.

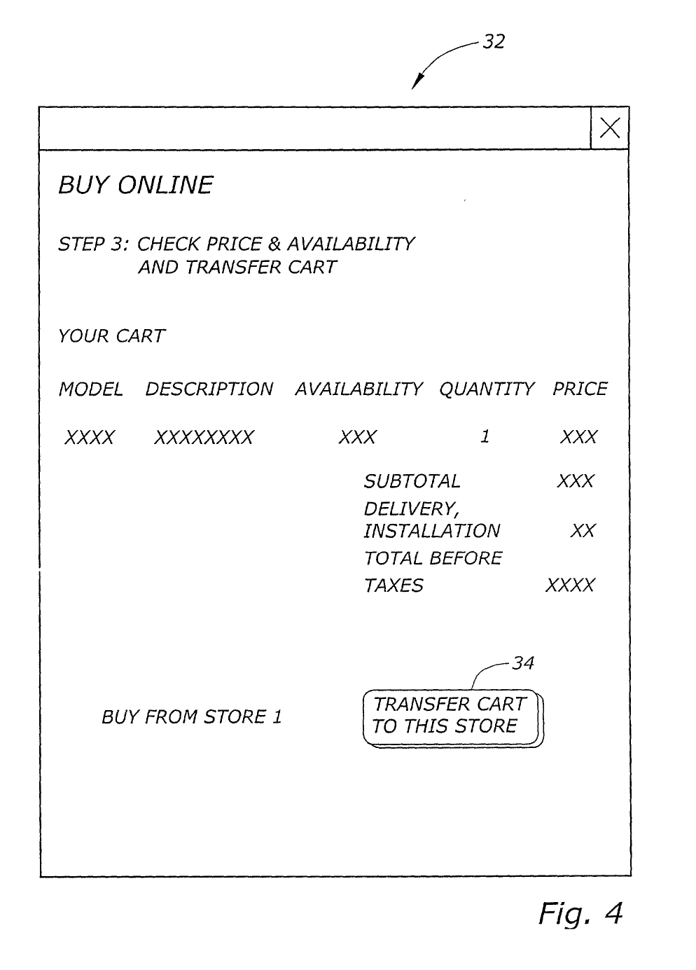

FIG. 4 is a graphical representation of a web page displayed on the first website that provides price and availability information at the associated website prior to transferring the cart. This provides the consumer with the opportunity to review this information to determine if the pricing terms associated with the second website are satisfactory. If so, then the user can select the “transfer cart to this store” button 34. This results in the cart being transferred from the first website to the second website.

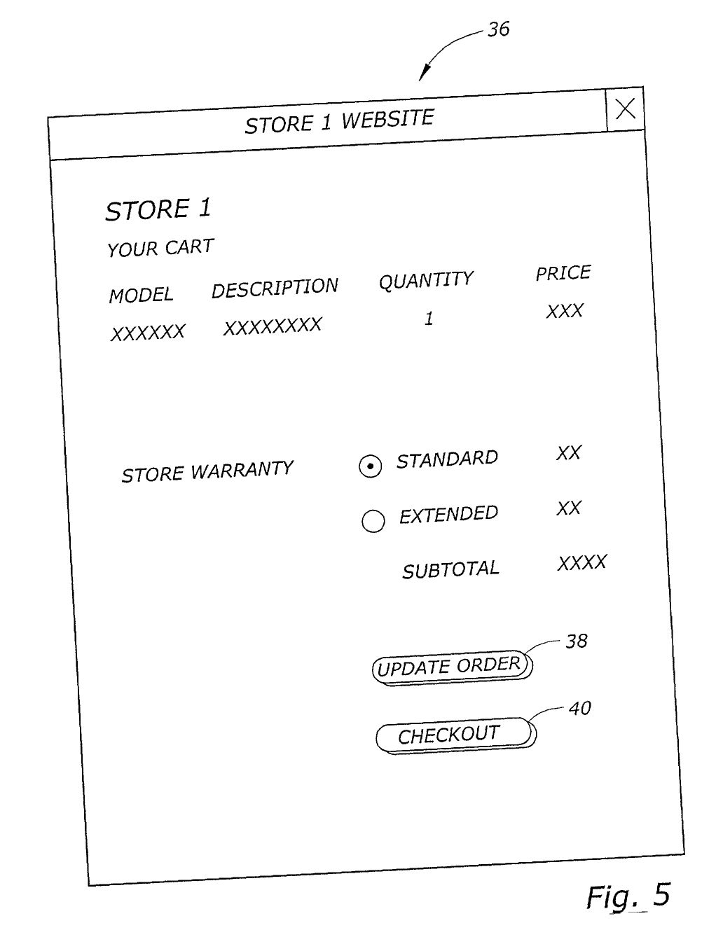

FIG. 5 is a pictorial representation of a web page of the second website of the present invention. Customer web page 36 is associated with a customer website under a customer's operation and/or control, or otherwise separate or distinct from the manufacturer's website. As shown in customer web page 36, product purchase selections made by a consumer at the manufacturer's website has been transferred to the customer website.

In this manner, a product purchase selection is transferred from a first website such as a manufacturer's website to a second website such as a customer's website.

The web pages may be created in any web development language, including HTML, XML, ASP, and JSP. It may include scripts, may be generated automatically, or otherwise such as well known in the art. The product selections may be transferred from the manufacturer's website to the customer website through sending XML, or other transfer mechanism, information from the manufacturer's website to the customer's website. This information may contain information about the customer, the product selections, or other information.

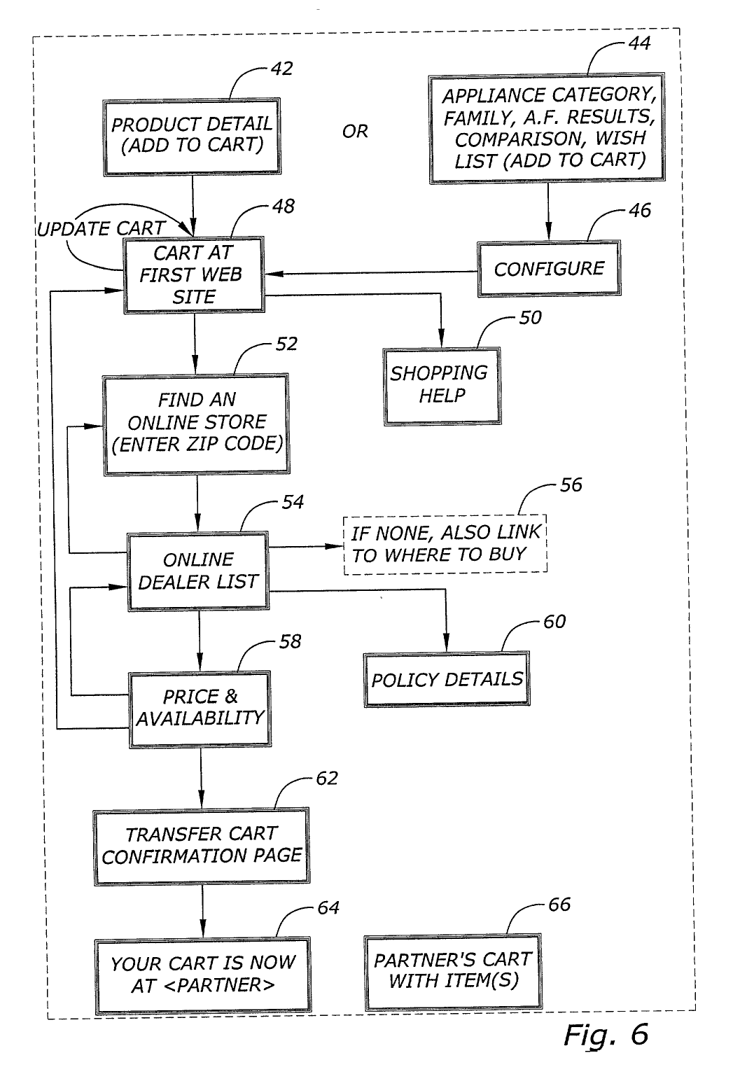

The transfer of product purchase selections from a manufacturer's website to a customer website can be performed in numerous ways. FIGS. 6, 7, and 8 show different implementations of the method and system of the present invention. In FIG. 6, a flow diagram of a manufacture website of the present invention is shown, “Product detail” web page 42 allows a consumer to view information concerning a particular product and then add that product to a cart 48 on a manufacturer's website. The present invention also contemplates that the product may be added to the cart 48 in other manners than directly from the product detail web page 42. For example, where the product is an appliance, the manufacturer's website may have other web pages that provide for product purchase selection. These other web pages for product purchase selection 44 include web pages that may provide a listing for products within a particular category, a listing of a family of products, products that are associated with results returned by an “appliance finder”, or other production selection tool products which are a part of a comparison chart, products which are on a wish list, and various other displays of product information in addition to product detail information. When these other alternatives for providing an opportunity for a consumer to make a product purchase selection or used, than a configure web page 46 may be used to provide additional information about product purchase selection. For example, if the product is an appliance, then a configure web page 46 may provide the consumer with an opportunity to select a color for the appliance, such as black, bisque or white. It should be readily apparent, that when other products are used, other configured information may be appropriate or desirable.

In cart web page 48, the contents of a shopping cart associated with the manufacturer's website are shown. Information associated with the cart may be updated, such as the quantities of an item. The cart web page 48 may also provide an opportunity for a consumer to receive a “shopping help” web page 50. The “shopping help” web page 50 provides general information about the online shopping process including information about viewing the cart, selecting an online partner store, checking price and availability of a product, transferring a cart, purchasing items from an online partner's website as well as other information that may be helpful for a consumer to know.

The consumer may then select a “find an online store” web page 52. This web page allows a consumer to find one or more online stores based upon a particular zip code. The present invention is in no way limited to selecting stores based solely on zip code. The present invention contemplates that other methods of selecting a store may be used. Furthermore, this step is optional as, for example, a complete list of online stores could be provided to the consumer. Alternatively, the consumer may have previously selected and stored a preferred online store, the manufacturer may assign a particular online store, or other variations may be used. According to FIG. 6, once the consumer enters a zip code to find an online store, an “online dealer list” web page 54 is shown that provides a listing of online dealers from which the consumer can elect to purchase the product. If there are no online stores carrying the product, then as indicated by box 56, the online dealer list may also include a link to where to buy the product from. In addition, the “online dealer list” web page 54 may also include a link to policy details for each of the online partner stores. A consumer may select the link in order to view the appropriate “policy details” web page 60.

The consumer also has an opportunity to select a “price and availability” link for each online store to navigate to a “price and availability” web page 58. The “price and availability” web page 58 provides the price for the selected product at that store as well as whether or not the selected product is currently available. This provides the consumer with an opportunity to then select a different store from this list by returning to the “online view list” web page 54 or if the price is not appropriate, to return to the “cart” web page 48 and remove the item from the cart.

If the consumer is satisfied with the product selected, the price and availability of the product at a particular store; as well as that store's policies, then the consumer may continue on to the “transfer cart confirmation” web page 62. This web page provides the consumer with an opportunity to confirm that they are prepared to transfer their cart containing its product purchase selections to the selected online store from the manufacturer's website. Once the consumer confirms transfer of the cart, then the consumer is presented with two pages. The first web page, “cart transferred” web page 64, alerts the consumer that the cart is now transferred to the online partner. Another web page, “partners cart” web page 66 is a web page at the customer's website. For example, this may be the web page 36 as shown in FIG. 5.

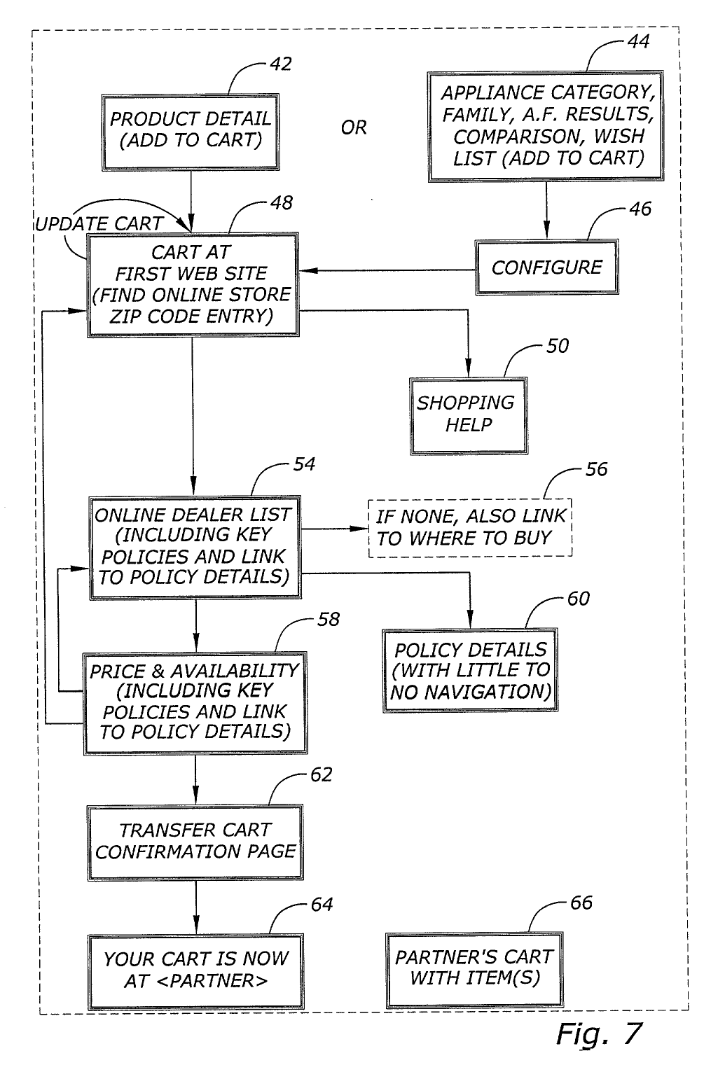

In this manner, transfer of product purchase selections from the manufacturer's website to the customer's website is performed. Another variation of the invention is shown in FIG. 7. In FIG. 7, the number of web pages that a consumer navigates through is reduced. In particular, the “cart” web page 48 contains a zip code selection so that the consumer can select a zip code directly from the cart web page 48. In addition, the “online dealer list” 54 web page includes key policies of the various online dealers within the list. There is still a link to the full policy details of web page 60. In addition, the “price and availability” web page 58 also contains the key policies of each store and links to policy details. In FIG. 7, it is shown that the various information may be moved to different web pages in order to facilitate quicker navigation for a consumer.

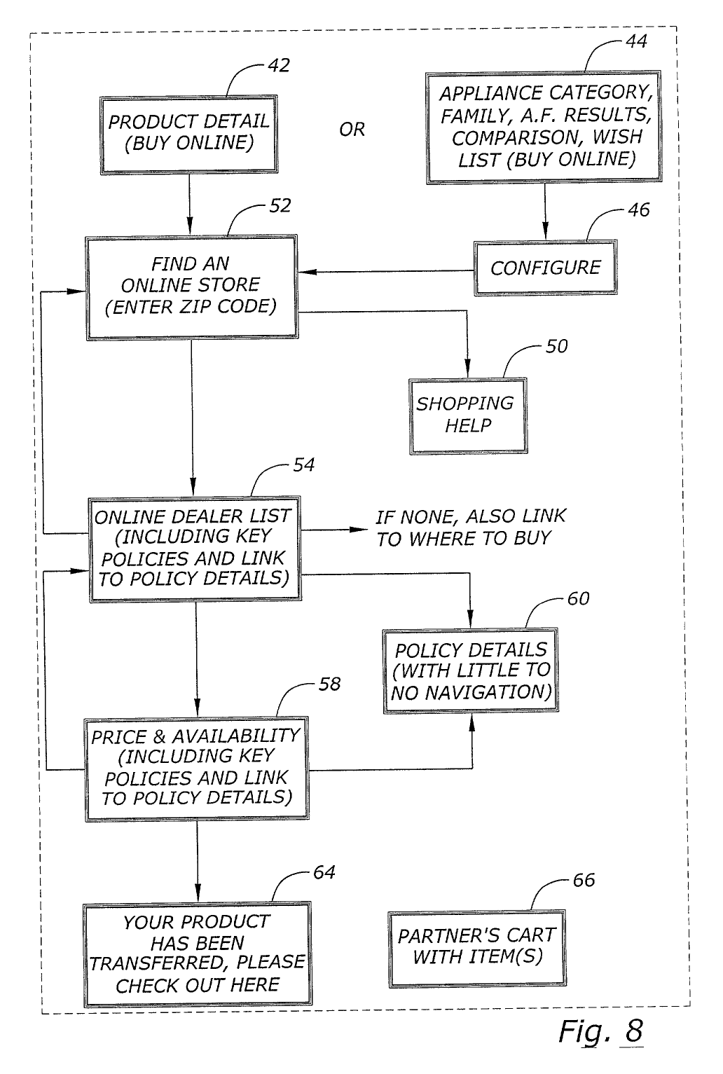

FIG. 8 shows another configuration of a system for providing online cart transfer of product purchase selections. In FIG. 8, the manufacturer's website does not have a shopping cart. However, the manufacturer's website does solicit the information required for product purchase selection so that this information can be transferred to a customer or partner's cart.

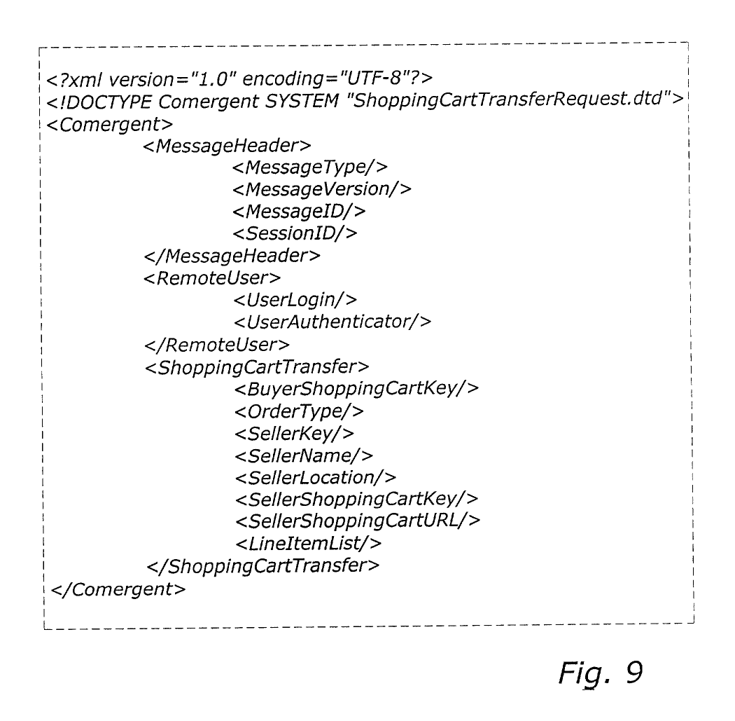

The transfer cart component of the present invention may be designed in various ways. For example, the transfer cart component may be in XML format. FIG. 9 provides one XML format for the transfer cart component of the present invention. The Comergent Distributed E-Business System, available from Comergent Technologies, Inc., may be used in implementing the present invention, but the present invention can be implemented through a variety of technologies and through products from a variety of vendors. According to the XML format of FIG. 9, a manufacturer web site passes product purchase selection information to a customer web site. This product purchase selection information can include a product identifier, message information, user information, seller information, and related information. The customer web site then receives this information contained in the cart transfer and based on this information, a corresponding cart is created on the customer web site containing the same product selections. The present invention contemplates that the customer web site may further require a translation component to receive the cart transfer and translate the cart transfer to comply with its electronic commerce system. However, this is not required when the customer web site can directly receive the cart transfer from the manufacturer's web site.

In addition to the cart transfer being an XML transfer, the cart transfer may be performed by passing variables, using an HTTP post, sharing a cookie, or other means. The present invention fully contemplates these and other variations.

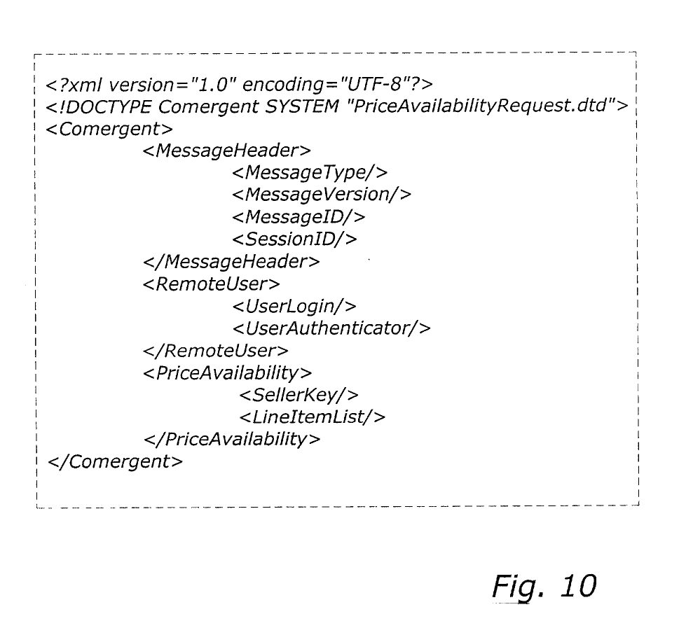

The check price and availability component of the present invention functions similarly to the cart transfer component. An example of an XML embodiment of the check price and availability component is shown in FIG. 10. The check price and availability component allows the manufacturer's web site the ability to receive price and availability information from a customer web site to display to consumers. The present invention contemplates that the check price and availability component may be implemented in numerous ways, including through the passing of variables, using an HTTP post, sharing a cookie, and other means. The present invention contemplates these and other variations.

A method and system for cart transfer in electronic commerce has now been disclosed. As should be apparent, the present invention contemplates numerous variations in the content of the particular web pages used to elicit product purchase selections, the manner in which customer websites are selected, the specific technical implementation, and other variations such as may be appropriate or desirable for a particular context.

What is claimed is:

1. An electronic commerce system for transfer of product purchase selection comprising:
a first website adapted to communicate product information to consumers and adapted to receive at least one product purchase selection from a consumer; and
a cart transfer for transferring the product purchase selection from the first website to a shopping cart of a second website.

2. The electronic commerce system of claim 1 further comprising one or more inputs for receiving information about consumer preferences.

3. The electronic commerce system of claim 1 wherein the first website is a manufacturer website and the second website is a customer website.

4. The electronic commerce system of claim 1 further comprising a shopping cart on the first website associated with the consumer and adapted to maintain the product purchase selection.

5. The electronic commerce system of claim 1 further comprising a customer selection component adapted for the consumer to select a second website.

6. The electronic commerce system of claim 5 further comprising a price and availability component for receiving price and availability of the product purchase selection from the second website.

7. The electronic commerce system of claim 1 wherein the product purchase selection is an appliance purchase selection.

8. The electronic commerce system of claim 1 wherein the cart transfer includes a XML transfer.

9. The electronic commerce system of claim 1 wherein the cart transfer includes passing a product identifier.

10. A method for electronic commerce comprising:
providing an online consumer with a web site having a view of a first shopping cart containing one or more product purchase selections;
receiving a selection of a customer website from the online consumer; and
transferring the product purchase selections from the first shopping cart to a second shopping cart on the customer website.

11. The method of claim 10 further comprising displaying a list of customer websites.

12. The method of claim 10 further comprising displaying pricing of a product purchase selection prior to transferring the product purchase selection.

13. The method of claim 10 further comprising displaying availability of a product purchase selection prior to transferring the product purchase selection.

14. The method of claim 10 further comprising displaying policies of the customer website prior to transferring the product purchase selection.
